(19) United States
(12) Patent Application Publication
(10) Pub. No.: US 2022/0044209 A1
(43) Pub. Date: Feb. 10, 2022

(54) METHOD AND DEVICE FOR CONFIRMING A LEGAL TRANSACTION

(71) Applicant: Robert Bosch GmbH, Stuttgart (DE)

(72) Inventors: Michael Schaefer, Walddorfhaeslach (DE); Alexander Poddey, Wiernsheim (DE); Christian Carl Bormann, Kornwestheim (DE)

(21) Appl. No.: 17/334,037

(22) Filed: May 28, 2021

(30) Foreign Application Priority Data
Aug. 6, 2020 (DE) 102020210000.4

(51) Int. Cl. G06Q 20/02; G06Q 10/10; G06Q 20/38; G06Q 20/06; G06Q 20/40; G06F 16/23

(52) U.S. Cl. CPC G06Q 20/02; G06Q 10/10; G06Q 20/389; G06Q 40/02; G06Q 20/405; G06F 16/2379; G06Q 20/0655

(57) ABSTRACT

A method for confirming a legal transaction. The method includes: instructions for the legal transaction are stipulated in a smart contract between a principal and an authorized agent, and the legal transaction is confirmed by the authorized agent on the basis of the contract in accordance with the principal's instructions.

### CROSS REFERENCE

The present application claims the benefit under 35 U.S.C. § 119 of German Patent Application No. DE 102020210000.4 filed on Aug. 6, 2020, which is expressly incorporated herein by reference in its entirety.

### FIELD

The present invention relates to a method for confirming a legal transaction. The present invention also relates to a corresponding device, to a corresponding computer program, and to a corresponding machine-readable memory medium.

### BACKGROUND INFORMATION

Any protocol in computer networks which brings about a consensus regarding the sequence of certain transactions is referred to as a decentralized transaction system, a transaction database, or a distributed ledger. One frequent characteristic of such a system is based on a blockchain and forms the basis of numerous so-called cryptocurrencies.

The consensus method most frequently used in the related art provides a proof of work (PoW) for generating new valid blocks. To counteract excessive energy consumption resulting from the provision of such proof, as well as unnecessary growth of the blockchain, so-called transaction channels or state channels have been proposed and generalized. An overview of this technology can be found in COLEMAN, Jeff; HORNE, Liam; XUANJI, Li, “Counterfactual: Generalized state channels,” 2018. German Patent Application No. DE 102018210224 A1 describes an embodiment including the following method for agreeing to a cooperation between two systems: The first system sends its acceptance regarding the second system and its guarantees granted thereto; reciprocally, the second system sends its acceptance regarding the first system and its guarantees granted thereto. A transaction database receives this reciprocal acceptance and guarantees, checks whether they match one another, optionally draws up a digital security contract to be concluded between the systems, and finally documents this by adding a corresponding block to a blockchain. It then sends the block containing the security contract to both systems, which start to collaborate as soon as they receive the block. For this purpose, they establish a reciprocal transaction channel, on which they exchange pieces of information and signed messages after receiving the block. If one of the systems receives a piece of information which violates the security contract, it asks the transaction database to arbitrate. The transaction database informs the other system of this, requests from the latter the piece of information which allegedly violates the security contract, and checks the piece of information with reference to the contract.

Such smart contracts typify the legal logic of every distributed application (dApp) of a transaction database. German Patent Application No. DE 102017214902 A1, for example, describes a smart contract for preparing and/or executing transactions between a holder of terminal equipment and a service provider, the smart contract containing conditions of the service provider for services of an information service provider, in particular conditions regarding usage fees, preferably road tolls, and/or for services of a service provider, in particular conditions regarding license fees, preferably regarding parking fees, fuel charges, fees for a charging station for the terminal equipment, and/or insurance conditions and/or conditions regarding utilization fees, preferably regarding fees for shared use of the terminal equipment in order to provide and/or cancel a service, and/or contains conditions defined by the holder of the terminal equipment for accepting and/or terminating the service, the smart contract being executed in a authorization node of a blockchain-based computer network.

As described in PCT Patent Application No. WO 2019180589 A1, on the basis of a so-called hash-lock method, suitably implemented payment or generalized state channels may also be used in cases where the trustworthiness of infrastructure and payment partners has not been proven. Such implementations will be referred to below as trustless channels.

### SUMMARY

The present invention provides a method for confirming a legal transaction, a corresponding device, a corresponding computer program, and a corresponding machine-readable memory medium.

The approach according to an example embodiment of the present invention is based on the finding that participation in digital financial systems—for example based on DLT and the associated expansion options, such as state channels, side chains, etc.—usually requires confirmation of individual financial transactions by the participant, for example for cryptographically signing transactions in a cryptography-based network.

Even for non-DLT-based systems, statutory regulations require an individual confirmation of each transaction by the participant, for example in the course of a value transfer. This applies for example to the transfer of funds via a banking application, in which the user has to confirm each individual debit entry individually. Exceptions are possible, in a strictly regulated form, for example by granting a direct debit authorization.

In many specific use scenarios in the context of the digital economy, this individual confirmation means that the participant either must remain online and make the relevant legal transactions at the correct time, or must permit a representative to sign on his/her behalf or using his/her electronic signature. Apart from the fact that the representative must then be online, this once again requires trust in the authorized party, the latter being able in principle to sign any transaction, and requires a significant amount of regulation in view of this trust-based action, particularly when the transactions are related to the transfer of assets.

These disadvantages are of particular importance for service providers in the digital economy sector, who typically wish neither to be online and sign each individual transaction themselves—consider, for example, a parking facility operator who has to sign off every parking operation—nor to use a digital agent who does this for them. The use of such an agent on behalf of the service provider by a party offering an agent operating service is laborious due to the regulatory requirements.

The provided approach in accordance with an example embodiment of the present invention enables a principal to transfer the confirmation of legal transactions to an authorized agent in an uncomplicated and cost-effective manner, thereby avoiding the aforementioned disadvantages.

Advantageous refinements and improvements to the basic features of the present invention are possible by virtue of the measures disclosed herein. For instance, it may be provided that the authorized agent is a software service operated by a service provider, and the principal is a customer of the service provider. In contrast to conventional methods of authorization, the authorized representative, which is operated as a service by a third party on behalf of the customer, in this case does not enjoy freedom of action since proper conduct may be enforced and misconduct may be documented in a forgery-proof manner and sanctioned. The administrative burden of operating such a service is therefore much lower than in the case of customary delegation models.

### BRIEF DESCRIPTION OF THE DRAWINGS

Exemplary embodiments of the present invention are shown in the figures and are explained in greater detail in the following description.

FIG. 1 shows the flowchart of a method according to a first specific embodiment.

FIG. 2 schematically shows a server according to a second specific embodiment.

### DETAILED DESCRIPTION OF EXAMPLE EMBODIMENTS

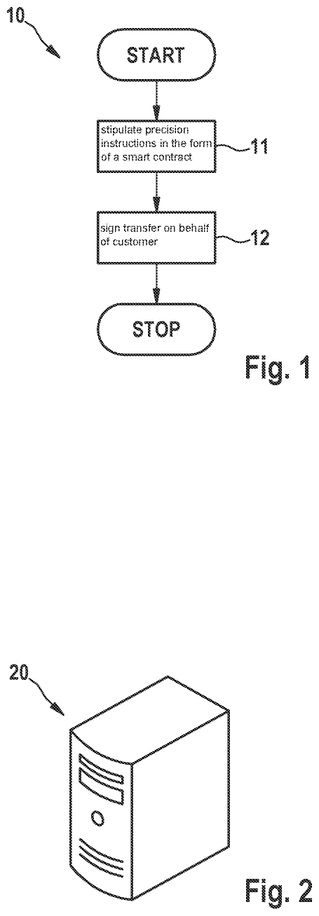

FIG. 1 illustrates the basic steps of the provided method 10, which are explained below by way of example on the basis of a blockchain-based cryptocurrency. In simplistic terms, the delegating participant in the blockchain and his authorized representative—which may be a software component operated by an independent body—may stipulate the precise instructions, according to which the service acting on behalf of the participant is to sign for the participant, in the form of a forgery-proof, digitally executable and evaluable smart contract (process 11).

The conduct of the authorized representative itself may then be derived directly from this smart contract, for example by executing the functions provided for in the contract within the blockchain (on-chain), outside of the blockchain (off-chain), or indirectly on the basis of the contract. A secure off-chain approach may be implemented using trustless channels.

In the event of disputes—for example, if the customer alleges that the conduct of the authorized representative deviates or has deviated from what is stipulated in the contract—the facts (deviation from the instructions or compliance with the instructions) may always be clarified by an arbitrator in the context of a trustless channel or even within the normal procedures of the applicable legal system.

Once the instructions have been stipulated 11, the software service may additionally make a deposit in the cryptocurrency, by which it is liable to the principal for any possible misconduct.

In one preferred embodiment, a user interface is available to the customer, which enables him/her to easily configure the rules of conduct for the agent acting as his/her authorized representative, the rules of conduct being then stipulated 11 in a formally checkable scripting language. Both parties sign this contract, for example as a dApp contract in a virtual channel network. The agent, as a service in the virtual machine of the cryptocurrency, may then for example sign transfers on behalf of the customer (process 12), without the customer himself/herself being online or having to control this.

The method 10 may for example be implemented in software or hardware or in a mixed form of software and hardware, for example in a server 20, as illustrated in the schematic diagram of FIG. 2.

What is claimed is:

1. A method for confirming a legal transaction, the method comprising the following steps:
stipulating instructions for the legal transaction in a smart contract between a principal and an authorized agent; and
confirming the legal transaction by the authorized agent based on the smart contract in accordance with the instructions.

2. The method as recited in claim 1, wherein:
the smart contract is drawn up in a scripting language, and
the scripting language is interpreted by a virtual machine of a decentralized transaction system.

3. The method as recited in claim 2, wherein:
the transaction system includes a blockchain, and
the confirmed legal transaction is added to the blockchain.

4. The method as recited in claim 2, wherein:
the transaction system includes a transaction channel, and
the confirmed legal transaction is added to the transactions acknowledged within the transaction channel.

5. The method as recited in claim 3, wherein:
the blockchain typifies a ledger of a cryptocurrency, and
the legal transaction is a transaction to be transacted in the cryptocurrency.

6. The method as recited in claim 5, wherein:
the authorized agent is a software service operated by a service provider, and
the principal is a customer of the service provider.

7. The method as recited in claim 6, wherein:
when a customer alleges that the software service has deviated from the instructions, an arbitrator determined by the transaction system is called upon, and
with reference to the contract and the alleged deviation, the arbitrator called upon checks the transaction for any misconduct by the service provider.

8. The method as recited in claim 7, wherein:
once the instructions have been stipulated, the software service makes a deposit in the cryptocurrency, and
by way of the deposit, the service provider is liable to the principal for the misconduct.

9. A non-transitory machine-readable memory medium on which is stored a computer program for confirming a legal transaction, the computer program, when executed by a computer, causing the computer to perform the following steps:
stipulating instructions for the legal transaction in a smart contract between a principal and an authorized agent; and
confirming the legal transaction by the authorized agent based on the smart contract in accordance with the instructions.

10. A device configured for confirming a legal transaction, the device configured to:
stipulate instructions for the legal transaction in a smart contract between a principal and an authorized agent; and
confirm the legal transaction by the authorized agent based on the smart contract in accordance with the instructions.
